(19) United States
(12) Patent Application Publication
(10) Pub. No.: US 2005/0063253 A1
(43) Pub. Date: Mar. 24, 2005

(54) Sun dial and method for determining average sunlight

(76) Inventor: Nevin Jenkins, Homosassa, FL (US)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 10/666,554

(22) Filed: Sep. 19, 2003

(51) Int. Cl. G04B 19/26

(52) U.S. Cl. 368/16

(57) ABSTRACT

A sun dial including a housing, a light detector mounted on the housing exposed to detect ambient light, a logic circuit mounted in the housing for processing the detected light for determining over a preselected period of time the average light detected by the light detector, and an indicator to indicate upon demand, the average light detected during the preselected period of time. A method for determining average light detected over a period of time by detecting light above a preselected threshold indicative of darkness, while noting the time of darkness, adjusting the period of time by subtracting the time of darkness from the period of time, calculating the average light detected over the adjusted period of time, and giving a visual indication of the average light detected.

### BACKGROUND OF THE INVENTION

1. Field of the Invention

The present invention relates to a sundial and method for determining average sunlight.

2. Prior Art

Heretofore, home gardeners have not had available a sun dial to indicate the current condition of the sunlight streaming into their homes, nor have they had the possibility of determining the average sunlight illuminating a given area of their homes for a period of time to give an indication of what kind of plant would best thrive in that area.

### SUMMARY OF THE INVENTION

The foregoing problem is solved by the present invention which provides a sun dial to give an indication of current sunlight and an average light over a period of time. This is accomplished by a sun dial consisting of a cylindrical housing that contains an electronic logic circuit that is driven by a light sensor, such as a photodetector. The circuitry is such that the sun dial is enabled to indicate the current condition of the sunlight for a given area and an average sunlight over a preselected period of time.

### BRIEF DESCRIPTION OF THE DRAWINGS

FIG. 1 is a perspective view of the sun dial of the present invention as seen from one side.

FIG. 2 is a perspective view of the sun dial of FIG. 1 as seen from the opposite side.

FIG. 3 is a circuit schematic showing the logic diagram of the electronic circuitry of the sun dial and illustrating the method of the invention.

### DETAILED DESCRIPTION OF PREFERRED EMBODIMENTS OF THE INVENTION

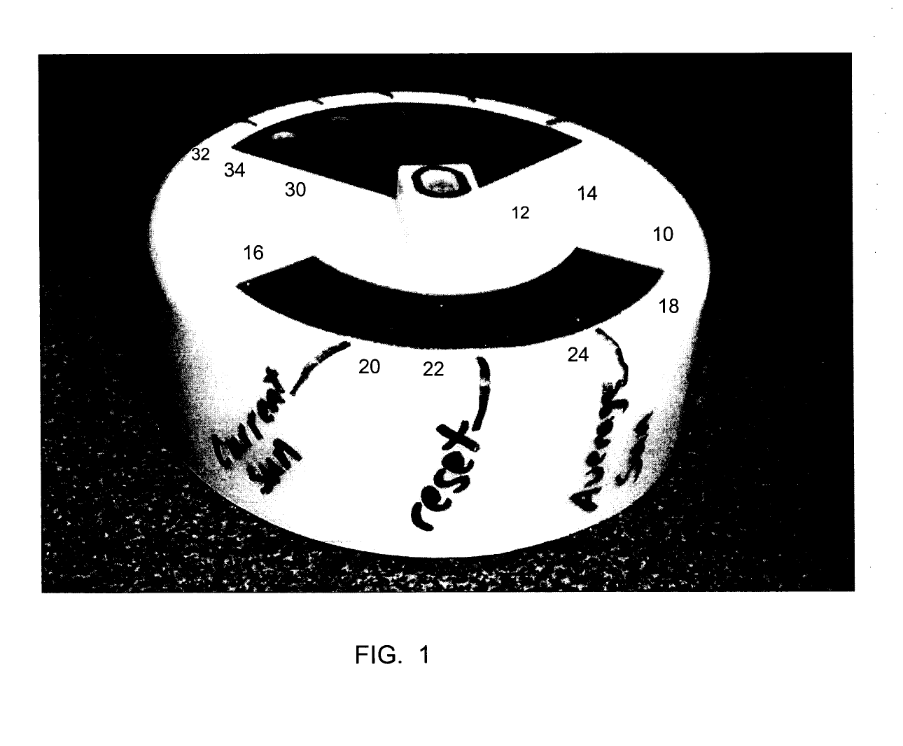

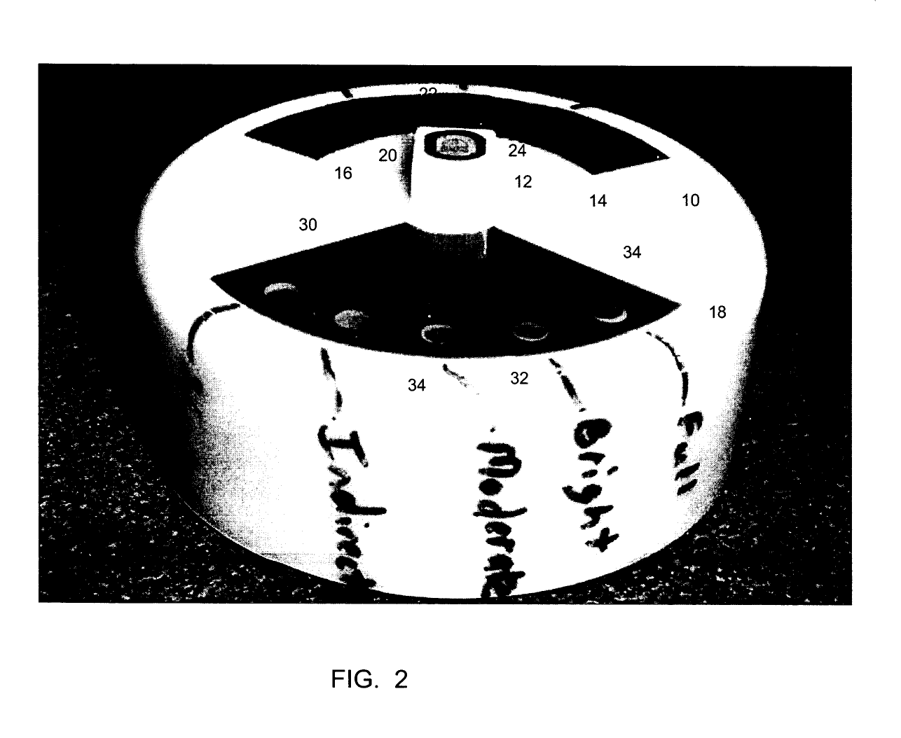

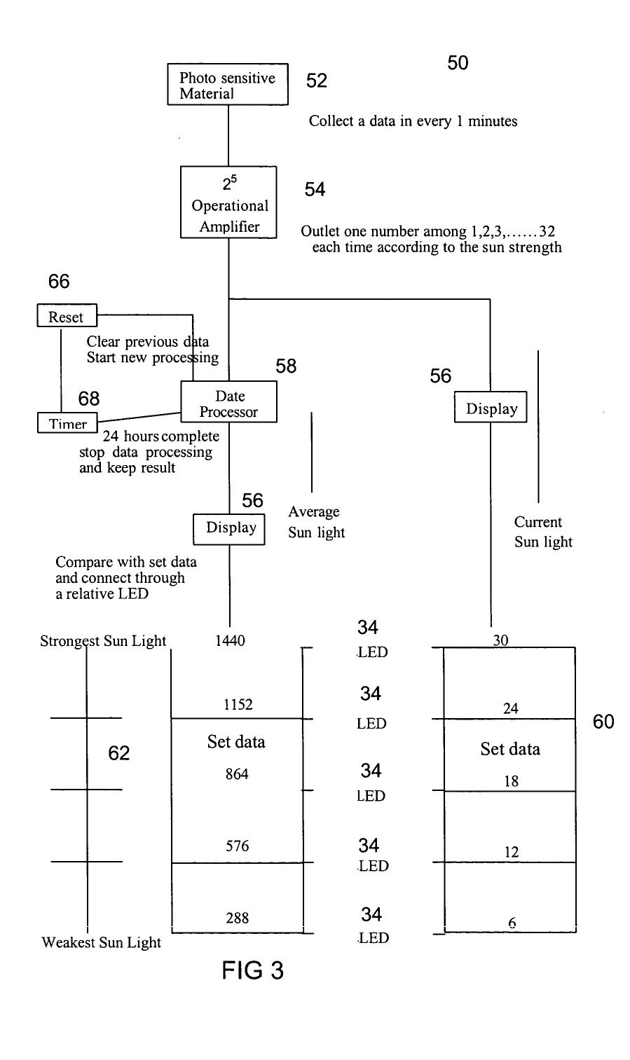

Referring now to the drawings, the invention will now be described in detail. As seen in FIGS. 1 and 2 the sun dial consists of a cylindrical housing 10 having an upstanding post 12 at the center of its top surface 14. One side of the top surface 14 is provided with an arcuate band 16 that parallel the outer edge 18 of the top surface 14, for about 60 arc degrees. Located in the band are three tactile switches 20, 22, 24 that are manually actuated by pressing down. As shown in FIG. 1 switch 20 when actuated will show current sun, switch 24 will show average sun, and switch 22 will reset the device. On the opposite side of the top surface 14 is a pie shaped band 30 that correlates with indicia 32 on the top edge 18 that indicates respectively, FULL (SUN), BRIGHT (SUN), MODERATE (SUN), INDIRECT (SUN) and SHADE. In the pie shaped band, adjacent the respective indicia are LEDs 34, which light up according to the condition to be indicated as determined by the logic circuit and program of FIG. 3.

The logic circuit is contained in the cylindrical housing 10 and is controlled by the switches 20 to 24.

As shown in FIG. 3, the logic circuit 50 consists of a photodetector 52 that is mounted at the top of the post 12 to be exposed to sunlight. The photodetector 52 is arranged to readout every minute, and its readout is fed to 2⁵ operational amplifier 54 that outputs a number from 1, 2, 3 to 32 for each cycle of the photodetector 52. The output from the operational amplifier 54 is available to the display 56 in the event the switch 20 is depressed to give a visual indication of the current sunlight. The displayed data of current sunlight is compared with set data 60 and the appropriate LED 34 is lit.

The output from the operational amplifier is also available to a data processor 58 to calculate average sunlight, which is indicated on display 56 in the event that switch 24 is depressed or actuated. The data of display 56 is compared with set data 62 and the appropriate LED 34 is lit.

As noted, the purpose of the reset button or switch is to reset the program for a new data cycle. Switch 22 is connected to the data processor 58 via the reset block 66 to effect this function. However, the set cycle is 24 hours under the control of timer 68 also connected to the data processor 58 and reset block 66, and the switch 22 is only enabling if depressed after 24 hours from initiation. If depressed before the expiration of 24 hours, the LEDs will flash repeatedly for a preselected time to alert the user that 24 hours has not elapsed, and the program will not stop, but will continue for the full 24 hour cycle.

Another important feature of the system is that the photodetector is provided with a threshold to detect a minimum amount of sunlight. If the amount of light is below the threshold, i.e. darkness, the photodetector will not produce an output, and the time of darkness will be recorded by the data processor and subtracted from the elapsed time for the computation of the average sun light, in order that a realistic measure of the average can be obtained.

Although the invention has been described and shown in terms of a preferred embodiment, nevertheless changes are possible which do not depart from the spirit or scope of the invention as recited in the appended claims. Such changes are deemed to come within the purview of the invention as claimed.

1. A sun dial comprising a housing, a light detector mounted on the housing exposed to detect ambient light, a logic circuit mounted in the housing for processing the detected light for determining over a preselected period of time the average light detected by the light detector, and an indicator to indicate upon demand, the average light detected during the preselected period of time.

2. A sun dial according to claim 1 wherein the logic circuit includes the processing of the detected light for determining the current light detected.

3. A sun dial according to claim 1 wherein the housing has mounted thereon switches to control the logic circuit.

4. A sun dial according to claim 1 wherein the logic circuit includes a data processor.

5. A sun dial according to claim 1 wherein LEDs are mounted on the housing to signal the average light detected.

6. A sun dial according to claim 5 wherein the LEDs selectively signal the current light and the average light.

7. A sun dial according to claim 1 wherein the logic circuit subtracts the times of darkness in computing the average light detected.

8. A sun dial according to claim 1 wherein the light detector is a photodetector including a threshold for controlling output.

9. A method for determining average light detected over a period of time comprising the steps of detecting light above a preselected threshold indicative of darkness, while noting the time of darkness, adjusting the period of time by subtracting the time of darkness from the period of time, calculating the average light detected over the adjusted period of time, and giving a visual indication of the average light detected.

10. A method for determining average light detected over a period of time according to claim 9 including the further step of selectively indicating the current light during the period of time.

11. A method for determining average light detected over a period of time according to claim 9 including the step of resetting after the period of time.

12. A method for determining average light detected over a period of time according to claim 11 including the further step of blocking reset until the expiration of the period of time.

13. A method for determining average light detected over a period of time according to claim 9 including the further step of providing the visual indication as one of a plurality of discrete increments.

14. A method for determining the average light in a given area of a room to be used for a plant comprising the steps of determining the average light received by the given area in a predetermined period of time, and providing a visual indication of the average light in order for a judicious selection of a plant for the given area can be made.
